(19) United States
(12) Patent Application Publication
(10) Pub. No.: US 2024/0062068 A1
(43) Pub. Date: Feb. 22, 2024

(54) MIXED SYNTHETIC DATA GENERATION

(71) Applicant: Accenture Global Solutions Limited, Dublin (IE)

(72) Inventors: Dimitrios Vlitas, London (GB); Aurora Armiento, London (GB); Henrietta Ridley, London (GB)

(21) Appl. No.: 17/891,476

(22) Filed: Aug. 19, 2022

(30) Foreign Application Priority Data
Aug. 17, 2022 (GR) 20220100693

(51) Int. Cl. G06N 3/08; G06N 3/04

(52) U.S. Cl. CPC G06N 3/088; G06N 3/0454

(57) ABSTRACT

Methods, systems, and apparatus, including computer programs encoded on a computer storage medium, for generating mixed synthetic data. In one aspect, a method includes obtaining a plurality of mixed input data. At least some of the plurality of mixed input data include one or more categorical variables and one or more continuous variables. The method includes training a machine learning model using the plurality of mixed input data and generating a plurality of mixed synthetic data. The plurality of mixed synthetic data (i) includes one or more categorical variables and one or more continuous variables and (ii) shares statistical properties with the plurality of mixed input data.

### CROSS-REFERENCE TO RELATED APPLICATION

The present application claims priority to Greek Patent Application Serial No. 20220100693, filed Aug. 17, 2022, which is incorporated by reference.

### TECHNICAL FIELD

This disclosure generally relates to artificial intelligence.

### BACKGROUND

Synthetic data generation aims to generate data that reproduce statistical properties of an original dataset. The synthetic data, instead of or in addition to the original dataset, can be used for training machine learning models. Augmenting a machine learning training dataset with the synthetic data is especially useful, when training data is limited.

### SUMMARY

This specification describes techniques for generating mixed synthetic data.

In general, an aspect of the subject matter described in this specification may involve a method including obtaining, by one or more processors, a plurality of mixed input data. At least some of the plurality of mixed input data include one or more categorical variables and one or more continuous variables. The method includes training a machine learning model using the plurality of mixed input data. Training the machine learning model includes generating a first encoding for the continuous variables; generating a second encoding for each of the categorical variables; combining the first and the second encodings with a dense layer, where the dense layer is configured to determine a mean and a standard deviation across the first and the second encodings; sampling at least some of the combined encodings; obtaining reconstructed data by processing sampled combined encodings to a decoder; and determining a loss of the reconstructed data from the plurality of mixed input data, wherein the loss includes a divergence error and a reconstruction error. The method includes generating, based on running the trained machine learning model, a plurality of mixed synthetic data. The plurality of mixed synthetic data (i) includes one or more categorical variables and one or more continuous variables and (ii) shares statistical properties with the plurality of mixed input data.

The foregoing and other embodiments can each optionally include one or more of the following features, alone or in combination. In some implementations, training the machine learning model includes using one or more variational autoencoders. In some implementations, the loss is a weighted sum of the divergence error and the reconstruction error. Weights combining the divergence and the reconstruction errors are determined heuristically. In some implementations, the divergence error is a Kullback-Leibler divergence of the mean and the standard deviation. In some implementations, the reconstruction error is a combination of a mean absolute error for the continues variables and a categorical cross entropy for the categorical variables. In some implementations, the method includes applying the machine learning model to the plurality of mixed input data, thereby obtaining the plurality of mixed synthetic data. In some implementations, the method includes providing at least some of the plurality of mixed synthetic data as an, input to training a second machine learning model. In some implementations, the machine learning model has been trained to minimize the loss. In some implementations, at least some of the one or more continuous variables are pixels representing one or more images.

Other embodiments of this aspect include corresponding computers systems, apparatus, and computer programs recorded on one or more computer storage devices, each configured to perform the actions of the methods. A system of one or more processors and one or more storage devices storing instructions that are operable, when executed by the one or more processors, to cause the one or more processors to perform operations. A non-transitory computer-readable medium, including software instructions, that when executed by a computer, cause the computer to execute operations.

The details of one or more embodiments of the subject matter of this specification are set, forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example of original data and synthetic data.

FIG. 1B is a block diagram of an example system for generating mixed synthetic data.

FIG. 2 is a block diagram of an example system for training a mixed synthetic data generation model.

FIG. 3 is a flowchart of example process for training a machine learning model and generating a plurality of mixed synthetic data.

Like reference symbols in the various drawings indicate like elements.

### DETAILED DESCRIPTION

According to an aspect of the present disclosure, systems and methods for generating mixed synthetic data are disclosed. The mixed synthetic data include both categorical, e.g., gender, hair color, presence of a disease, and continuous variables, e.g., image, height, weight, body temperature, that retain statistical properties, e.g., distributions of the variables, of original data. The mixed synthetic data can be utilized, instead of or in addition to the original data, in training machine learning models. The mixed synthetic data, while having similar statistical properties to the original data, do not reveal identifiable information about a person the data are derived from.

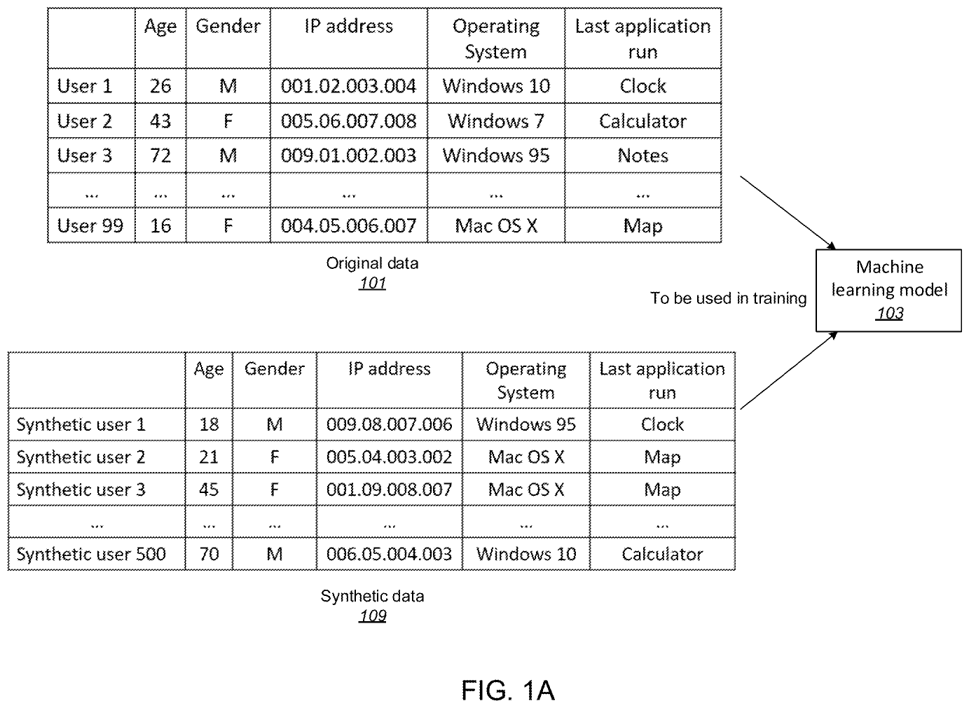

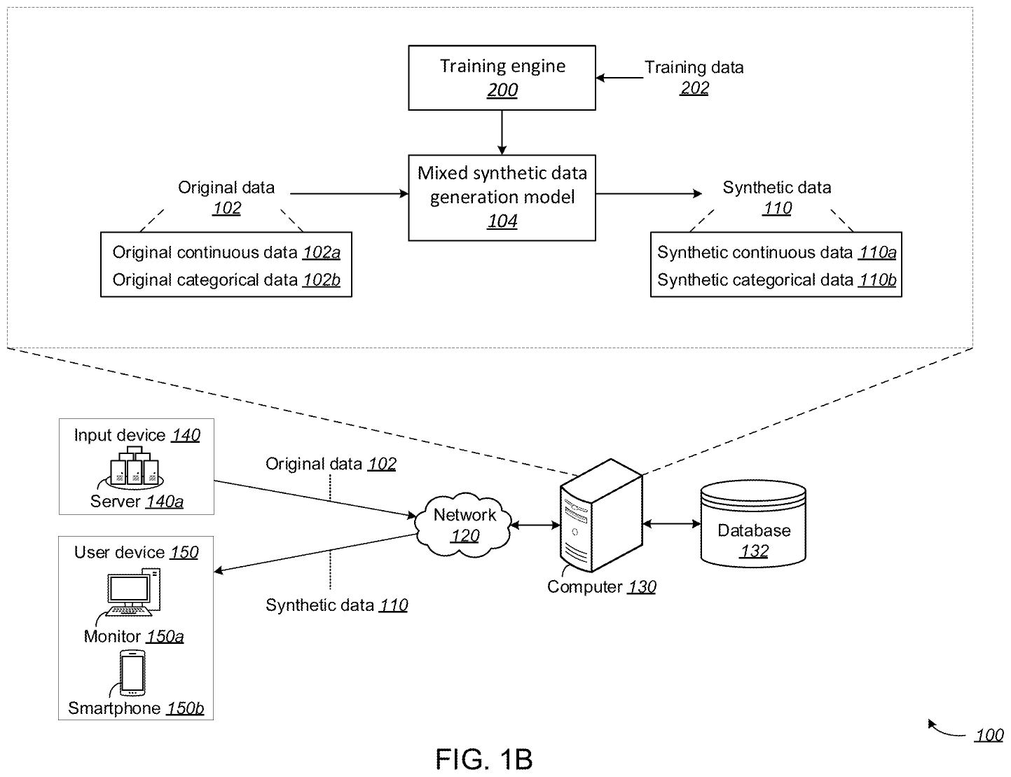

FIG. 1A shows an example of original data and synthetic data. Roth the original data and the synthetic data are used in training a machine learning model 103 that predicts a computer network bottleneck across users who share the same network, e.g., which user likely causes data overload. The original data 101 include, for each user, age, gender, internet protocol (IP) address, operating system, and last application run on the user's device. For example, user 3, who is 72-year-old male, used Notes most recently on his Windows 95 operating system with IP address of 009.01.002.003. Age and IP address are continuous variables; gender, operating system, and last application run are categorical variables. Based on the original data 101, the synthetic data 109 are generated. As shown in FIG. 1A, the size of the synthetic data 109 can be set, e.g., 500 synthetic users. The synthetic users are not real-world users, such as the user 3, but rather reproduce attributes of the real-world users such that the distributions of the variables are similar to the original data 101. Thus, similar to the original data 101, the synthetic data 109 include both categorical and continuous variables for 500 synthetic users. When trained on only the original data 101, the machine learning model 103 may not achieve a high accuracy. This is because there are only 99 user data in the original data 101, and the original data 101 are imbalanced such that there are not enough female user data. To improve the accuracy of the machine learning model 103, the synthetic data 109 can be used, in addition to the original data 101, for training. In some implementations, due to privacy requirements of the user data, only the synthetic data 109 might be usable in training the machine learning model 103.

The approaches described here in generating mixed synthetic data, including a particular architecture used to model probabilistic properties of each variable of the original data, can provide following advantages. First, the mixed synthetic data meet privacy requirements of handling the original data. For example, the original data are medical records of individuals and thus need to meet a certain privacy requirement, limiting data usage in training machine learning models. Second, the mixed synthetic data enables improving accuracy of machine learning models by augmenting training datasets. For example, when available training datasets are highly imbalanced, e.g., 99% data from male, a trained machine learning model based on only available training datasets is likely perform poorly on female. The mixed synthetic data can be added to offset the imbalanced training datasets, resulting in improved accuracy of the machine learning model. As yet another example, when availability of original data is highly limited, the mixed synthetic data enables training machine learning models that meet an acceptable level of performance. Third, compared to non-mixed synthetic data, generation, the mixed synthetic data do not pose challenges in implementation of variational autoencoders (VAEs), an unsupervised approach of generating an output representative of input data by compressing the input data using encoders and reconstructing the input data using decoders.

FIG. 113 is a block diagram of an example system 100 for generating mixed synthetic data. The system 100 obtains original data 102 and generates synthetic data 110. The system 100 includes an input device 140, a network 120, and one or more computers 130, e.g., one or more local or cloud-based processors. The computer 130 can include a mixed synthetic data generation model 104 and a training engine 200. In some implementations, the computer 130 is a server. For purposes of the present disclosure, an “engine” can include one or more software modules, one or more hardware modules, or a combination of one or more software modules and one or more hardware modules. In some implementations, one or more computers are dedicated to a particular engine. In some implementations multiple engines can be installed and running on the same computer or computers.

The input device 140 is a device that is configured to obtain original data 102, a device that is configured to provide original data 102 to another device across the network 120, or any suitable combination thereof. The original data 102, as opposed to synthetic data, represent data obtained by direct measurements. For example, the input device 140 can include a server 140a that is configured to obtain medical or financial records of patients. In some implementations, the server 140a can obtain and transmit the original data 102 to another device such as the computer 130 across the network 120. In some implementations, the server 140a can obtain original data 102 that can be accessed by one or more other input devices 140 such as computer, e.g., desktop, laptop, and tablet, a smartphone, or a server. In such instances, the one or more other input devices can access the original data 102 obtained by the server 140a and transmit the obtained original data 102 to the computer 130 via the network 120. The network 120 can include one or more of a wired Ethernet network, a wired optical network, a wireless WiFi network, a LAN, a WAN, a Bluetooth network, a cellular network, the Internet, or other suitable network, or any combination thereof. In some implementations, the server 140a and the computer 130 are the same.

The computer 130 is configured to obtain original data 102 from the input device 140 such as the server 140a. In some implementations, the original data 102 can be data received over the network 120. In some implementations, the computer 130 can store at least some of the original data 102 in a database 132 and access the database 132 to retrieve the stored original data. The database 132, such as a local database or a cloud-based database, can store the original data 102 that are encrypted and/or standardized. As an example of medical records, each of the original data 102 include patient name, medical history, or other suitable data.

In some implementations, the computer 130 processes original data 102 such that each dataset in the original data 102 is in the same, standardized format. For example, the computer 130 imputes missing values based on datasets similar to a dataset with missing values. The computer 130 can also apply transformations, e.g., converting units and normalizing values, and data deduplication to at least some of the original data 102 for standardization.

The mixed synthetic data generation model 104, also referred to as the model 104, is configured to receive the original data 102 and generate synthetic data 110. The model 104 processes the original data 102 such that the resulting output of the model reproduces the statistical properties of the original data 102, regardless whether the original data 102 include only continuous or categorical variables, or combinations of continuous and categorical variables. As an output of applying the model 104 to the original data 102, the synthetic data 110 includes synthetic continuous data 110a corresponding to the original continuous data 102a and synthetic categorical data 110b corresponding to the original categorical data 102b. The synthetic data 110 can be stored in the database 132. In some implementations, the synthetic data 110 are displayed on a device having a display such as a user device 150, e.g., a computer having a monitor 150a, a mobile computing device such as a smart phone 150b, or another suitable user device. Rendering data generated by the computer 130 can be transmitted to the user device 150 through the network 120 and processed by the user device 150 or associated processor to generate output data for display on the user device 150. In some implementations, the user device 150 can be coupled to the computer 130. In such instances, the rendered data can be processed by the computer 130, and cause the computer 130, on a user interface, to output the synthetic data 110.

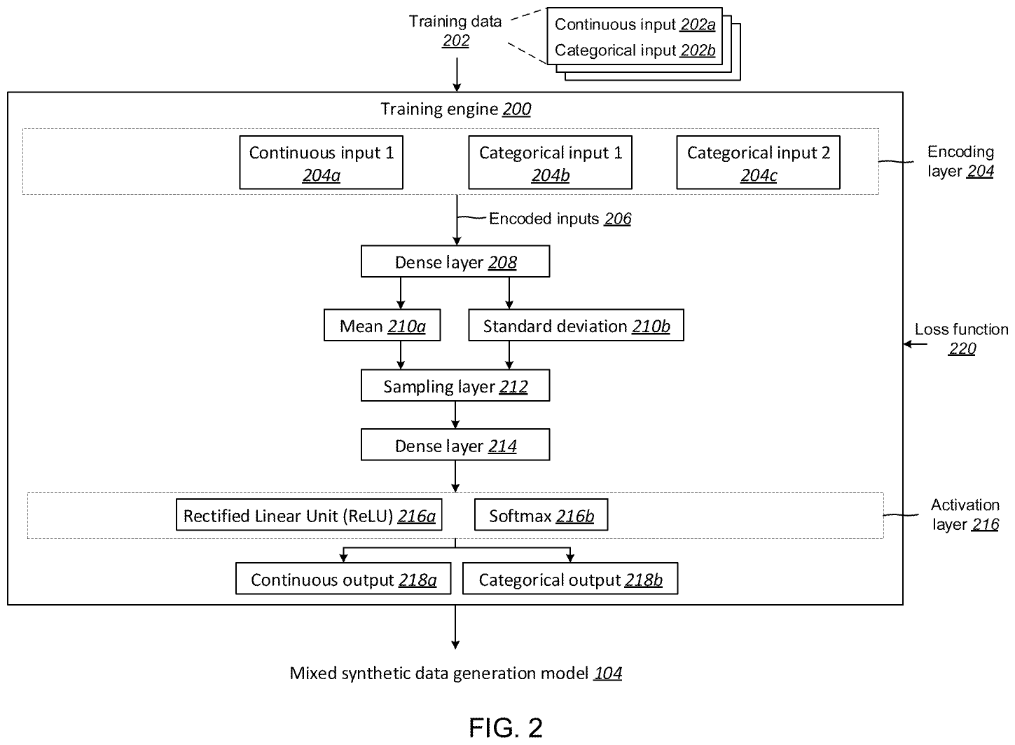

The model 104 is trained by the training engine 200 using training data 202. Referring to FIG. 2, the training engine 200 receives the training data 202 that include both continuous input 202a and categorical input 202b. For example, the training data 202 include medical records of patients such as height, weight, gender, and treatment plan. As yet another example, referring to FIG. 1A, the training data 202 include user data related to a computer network. The training engine 200 uses the training data 202 to learn parameters of neural networks such that a loss function 220 of reconstructed data, continuous output 218a and categorical output 218b, from the training data 202 is minimized. The loss function 220 includes a divergence error and a reconstruction error.

The training engine 200 processes the training data 202 through multiple layers. An encoding layer 204, which is a first layer of the multiple layers, obtains the training data 202 and generates a first encoding for the continuous inputs and a second encoding for each of the categorical inputs. For example, if there are 10 continuous inputs in the training data 202, the 10 continuous inputs get fed into an encoder that generates a 10-dimensional vector. If there are 8 categorical inputs, each of the 8 categorical inputs is fed into an encoder that generates a one-hot encoding. As an output of the encoding layer 204, encoded inputs 206 are combined by a dense layer 208, a neural network layer that is connected deeply. The dense layer determines a mean 210a and a standard deviation 210b across the encoded inputs 206. The mean 210a and the standard deviation 210b are also referred to as the global mean and standard deviation. A sampling layer 212 samples encodings to be fed into a decoder. The sampling is done from a low-dimensional distribution of the training data 202 based on the global mean and standard deviation. In some implementations, the sampling layer 212 uses variational autoencoder reparametrization trick. A dense layer 214 decodes sampled combined encodings. An activation layer 216 outputs a combination of continuous output 218a and categorical output 218b, using rectified linear unit (ReLU) 216a for activating continuous inputs and a softmax 216b for activating categorical inputs. As an output of training, the training engine 200 outputs the mixed synthetic data generation model 104.

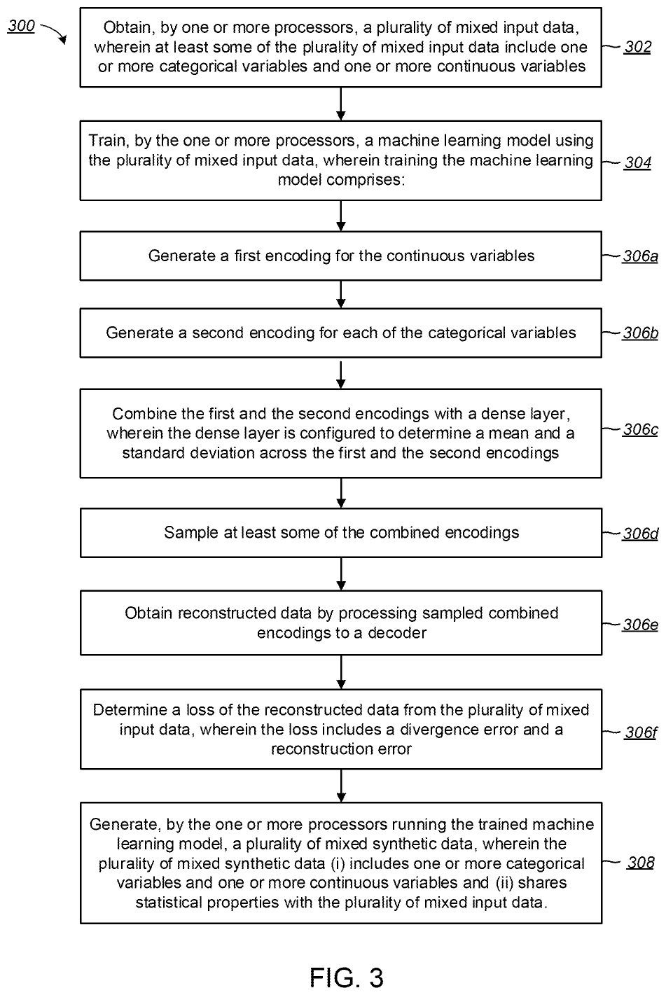

FIG. 3 is a flowchart of an example of a process 300 for training a machine learning model and generating a plurality of mixed synthetic data based on the trained machine learning model. The process will be described as being performed by a system of one or more computers programmed appropriately in accordance with this specification. For example, the computer 130 of FIG. 1B can perform at least a portion of the example process. In some implementations, various steps of the process 300 can be run in parallel, in combination, in loops, or in any order.

The system obtains a plurality of mixed input data (302). At least some of the plurality of mixed input data include one or more categorical variables, e.g., gender, and one or more continuous variables, e.g., age, height. In some implementations the system obtains the plurality of mixed input data from multiple different computing systems. Each computing system may format data differently; in this case, the system can apply standardization across the plurality of mixed input data to standardize how each data is, formatted. In some implementations, at least some of the one or more continuous variables are pixels representing images. The images are represented by continuous variables, e.g., a matrix of numbers indicative of pixels of the images. In some implementations, the system processes the plurality of mixed input data such that missing values are imputed, e.g., based on other similar mixed input data.

The system trains a machine learning model using the plurality of mixed input data (304). The machine learning model is configured to generate a plurality of mixed synthetic data. Training the machine learning model includes the following subprocesses 306a-306f. In some implementations, the machine learning model uses one or more variational autoencoders.

As described referring to FIG. 2, the system generates a first encoding for the continuous variables (306a). The system generates a second encoding for each of the categorical variables (306b). The system combines the first and the second encodings with a dense layer (306c). The dense layer is configured to determine a mean and a standard deviation across the first and the second encodings. The system samples at least some of the combined encodings (306d). The system obtains reconstructed data by processing sampled combined encodings to a decoder (306e).

The system determines a loss of the reconstructed data from the plurality of mixed input data (3060. The loss includes a divergence error and a reconstruction error. The machine learning model has been trained to minimize the loss. For example, during iterations of training the machine learning model, parameters of neural networks are modified such that the loss is reduced. In some implementations, the loss is a weighted sum of the divergence error and the reconstruction error, where weights combining the divergence and the reconstruction errors are determined heuristically. In some implementations, the divergence error is a Kullback-Leibler divergence of the mean and the standard deviation. In some implementations, the reconstruction error is a combination of a mean absolute error for the continues variables and a categorical cross entropy for the categorical variables.

The system, based on the trained machine learning model, generates a plurality of mixed synthetic data (308). The plurality of mixed synthetic data (i) includes one or more categorical variables and one or more continuous variables and (ii) shares statistical properties with the plurality of mixed input data.

In some implementations, the system provides at least some of the plurality of mixed synthetic data as an input to training a second machine learning model. For example, the original data may be insufficient in training the second machine learning model that require a certain number of training data. Augmenting the original data with the synthetic data can result in training the second machine learning model that is well-powered due to enough training data. In some implementations, the second machine learning model is a supervised machine learning, e.g., support vector machines, random forest, and gradient boosting, that performs classification on input data. In some implementations, the system displays at least some of the plurality of mixed synthetic data on a user interface, e.g., in a tabular form.

This specification uses the term “configured” in connection with systems and computer program components. For a system of one or more computers to be configured to perform particular operations or actions means that the system has installed on it, software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term data processing apparatus refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks. e.g., internal, hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production. i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited, in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

1. A computer-implemented method comprising:
obtaining, by one or more processors, a plurality of mixed input data, wherein at least some of the plurality of mixed input data include one or more categorical variables and one or more continuous variables; and
training, by the one or more processors, a machine learning model using the plurality of mixed input data, wherein training the machine learning model comprises:
generating a first encoding for the continuous variables;
generating a second encoding for each of the categorical variables;
combining the first and the second encodings with a dense layer, wherein the dense layer is configured to determine a mean and a standard deviation across the first and the second encodings;
sampling at least some of the combined encodings;
obtaining reconstructed data by processing sampled combined encodings to a decoder; and
determining a loss of the reconstructed data from the plurality of mixed input data, wherein the loss includes a divergence error and a reconstruction error; and
generating, by the one or more processors running the trained machine learning model, a plurality of mixed synthetic data, wherein the plurality of mixed synthetic data (i) includes one or more categorical variables and one or more continuous variables and (ii) shares statistical properties with the plurality of mixed input data.

2. The computer-implemented method of claim 1, wherein training the machine learning model uses one or more variational autoencoders.

3. The computer-implemented method of claim 1, wherein the loss is a weighted sum of the divergence error and the reconstruction error, wherein weights combining the divergence and the reconstruction errors are determined heuristically.

4. The computer-implemented method of claim 3, wherein the divergence error is a Kullback-Leibler divergence of the mean and the standard deviation.

5. The computer-implemented method of claim 3, wherein the reconstruction error is a combination of a mean absolute error for the continues variables and a categorical cross entropy for the categorical variables.

6. The computer-implemented method of claim 1, further comprising:
providing at least some of the plurality of mixed synthetic data as an input to training a second machine learning model.

7. The computer-implemented method of claim 1, wherein training the machine learning model comprises minimizing the loss.

8. The computer-implemented method of claim 1, wherein at least some of the one or more continuous variables are pixels representing one or more images.

9. A system comprising:
one or more processors and one or more storage devices storing instructions that are operable, when executed by the one or more processors, to cause the one or more processors to perform operations comprising:
obtaining, by the one or more processors, a plurality of mixed input data, wherein at least some of the plurality of mixed input data include one or more categorical variables and one or more continuous variables; and
training, by the one or more processors, a machine learning model using the plurality of mixed input data, wherein training the machine learning model comprises:
generating a first encoding for the continuous variables;
generating a second encoding for each of the categorical variables;
combining the first and the second encodings with a dense layer, wherein the dense layer is configured to determine a mean and a standard deviation across the first and the second encodings;
sampling at least some of the combined encodings;
obtaining reconstructed data by processing sampled combined encodings to a decoder; and
determining a loss of the reconstructed data from the plurality of mixed input data, wherein the loss includes a divergence error and a reconstruction error; and
generating, by the one or more processors running the trained machine learning model, a plurality of mixed synthetic data, wherein the plurality of mixed synthetic data (i) includes one or more categorical variables and one or more continuous variables and (ii) shares statistical properties with the plurality of mixed input data.

10. The system of claim 9, wherein the loss is a weighted sum of the divergence error and the reconstruction error, wherein weights combining the divergence and the reconstruction errors are determined heuristically.

11. The system of claim 10, wherein the divergence error is a Kullback-Leibler divergence of the mean and the standard deviation.

12. The system of claim 9, further comprising:
providing at least some of the plurality of mixed synthetic data as an input to training a second machine learning model.

13. The system of claim 9, wherein training the machine learning model comprises minimizing the loss.

14. The system of claim 9, wherein at least some of the one or more continuous variables are pixels representing one or more images.

15. The system of claim 9, wherein training the machine learning model uses one or more variational autoencoders.

16. A non-transitory computer-readable medium, comprising software instructions, that when executed by a computer, cause the computer to execute operations comprising:
obtaining, by the computer, a plurality of mixed input data, wherein at least some of the plurality of mixed input data include one or more categorical variables and one or more continuous variables; and
training, by the computer, a machine learning model using the plurality of mixed input data, wherein training the machine learning model comprises:
generating a first encoding for the continuous variables;
generating a second encoding for each of the categorical variables;
combining the first and the second encodings with a dense layer, wherein the dense layer is configured to determine a mean and a standard deviation across the first and the second encodings;
sampling at least some of the combined encodings;
obtaining reconstructed data by processing sampled combined encodings to a decoder; and
determining a loss of the reconstructed data from the plurality of mixed input data, wherein the loss includes a divergence error and a reconstruction error; and
generating, by the computer running the trained machine learning model, a plurality of mixed synthetic data, wherein the plurality of mixed synthetic data (i) includes one or more categorical variables and one or more continuous variables and (ii) shares statistical properties with the plurality of mixed input data.

17. The non-transitory computer-readable medium of claim 16, wherein the loss is a weighted sum of the divergence error and the reconstruction error, wherein weights combining the divergence and the reconstruction errors are determined heuristically.

18. The non-transitory computer-readable medium of claim 16, further comprising:
providing at least some of the plurality of mixed synthetic data as an input to training a second machine learning model.

19. The non-transitory computer-readable medium of claim 16, wherein at least some of the one or more continuous variables are pixels representing one or more images.

20. The non-transitory computer-readable medium of claim 16, wherein training the machine learning model uses one or more variational autoencoders.
